(19) United States
(12) Patent Application Publication
(10) Pub. No.: US 2005/0184096 A1
(43) Pub. Date: Aug. 25, 2005

(54) Vehicle fluid delivery apparatus and method

(76) Inventor: Kimothy C. Levia, Ile Bizard (CA)

Correspondence Address: WEISS & MOY PC, 4204 NORTH BROWN AVENUE, SCOTTSDALE, AZ, 85251, US

(21) Appl. No.: 10/784,664

(22) Filed: Feb. 23, 2004

(51) Int. Cl. B67D 5/06

(52) U.S. Cl. 222/181.2

(57) ABSTRACT

A flexible vehicle fluid container holds vehicle fluid, which is poured therefrom into a fill opening for vehicle fluid. The container preferably has a nozzle, to which is coupled a first end of a hose, the second end of which is positioned proximate (and preferably within) a vehicle fluid fill opening. The vehicle fluid may be, for example, brake fluid, motor oil, transmission oil, power steering fluid, or other fluids required for the care, maintenance, and/or cleaning of a vehicle. Preferably, the container may be attached to an object during filling, such as a vehicle hood or a mobile carrier.

### FIELD OF THE INVENTION

This invention relates generally to apparatuses and methods for the delivery of vehicle fluids (such as brake fluid, oil, transmission fluid, etc.) and, more particularly, to a vehicle fluid delivery apparatus and method wherein vehicle fluid is stored in and dispensed from a flexible bladder.

### BACKGROUND OF THE INVENTION

The care and maintenance of vehicles requires the periodic delivery of a variety of vehicle fluids to appropriate fill openings in a vehicle's engine compartment. Common vehicle fluids include brake oil, transmission fluid, gear oil, engine oil, additives, anti-freeze/coolant, engine shampoo or cleaner, and window cleaner.

Typically, such fluids are stored in hard plastic or metal containers. When the fluids are dispensed, this typically occurs by pouring the liquid from the container, through a funnel or directly, into the suitable fluid opening.

Particularly where a funnel is not used, the current method can be messy and wasteful, particularly where the fill opening is in a difficult-to-reach position within the engine compartment (such as is typically the case with the fill opening for power steering fluid). Even where a funnel is used, other problems are present. For example, there is a risk of contamination where a funnel is used for the delivery of different fluid types. In addition, even with a funnel, the risk of mess is still present.

In addition to problems of mess and waste, present methods can have other negative consequences. For example, there is a risk of water or other contamination with respect to some prior art containers. This can be particularly problematic where brake fluid is concerned. Brake fluid is hydroscopic, i.e., it absorbs water. The amount of moisture in brake fluid negatively affects brake performance. SAE field tests have shown that the average one-year-old car has 2% moisture in the fluid. A random test of vehicles in the U.S. showed average water content of 2.6% for vehicles with an average age of 8 years. 25% of the vehicles tested had water content greater than 4%.

As water content in brake fluid increases over time, the boiling point decreases. Fluid with a reduced boiling point (or high water content) can create vapor by boiling in the caliper, or wheel cylinder. The result is sudden brake failure. In addition, water in the brake fluid can contribute to corrosion of parts such as steel pistons and ABS modulators.

In addition, prior art rigid plastic containers utilize a relatively significant amount of plastic. This contributes to a higher than necessary manufacturing expense, and a greater than needed amount of waste when disposing of empty fluid containers.

A need therefore existed for a vehicle fluid dispensing apparatus that permits the cleaner and less wasteful dispensing of vehicle fluids. A need further exists for a vehicle fluid dispensing apparatus that utilizes less plastic as compared to prior art plastic dispensers, and that is smaller in size when in an empty condition. The present invention satisfies these needs and provides other, related, advantages.

### SUMMARY OF THE INVENTION

In accordance with an embodiment of the present invention, a vehicle fluid delivery apparatus is disclosed. The apparatus comprises, in combination: a flexible vehicle fluid container; vehicle fluid located in the flexible bladder; a first nozzle coupled to the flexible bladder and permitting the vehicle fluid to exit the flexible bladder; and a hose coupled at a first end thereof to the first nozzle.

In accordance with another embodiment of the present invention, a method for providing vehicle fluid to a vehicle is disclosed. The method comprises the steps of: providing a flexible vehicle fluid container; inserting vehicle fluid into the flexible vehicle fluid container; providing a first nozzle coupled to the flexible bladder and permitting the vehicle fluid to exit the flexible bladder; providing a hose coupled at a first end thereof to the first nozzle; positioning the first nozzle proximate a fill opening for vehicle fluid; permitting the vehicle fluid to exit the flexible vehicle fluid container and enter the fill opening.

### BRIEF DESCRIPTION OF THE DRAWINGS

FIG. 1 is a perspective view of a vehicle fluid delivery apparatus, consistent with an embodiment of the present invention, being utilized to delivery vehicle fluid to a vehicle.

FIG. 2 is a perspective, partially cross-sectional, view of a vehicle fluid delivery apparatus, consistent with an embodiment of the present invention, illustrating various apparatus components.

FIG. 3 is a front view of the bladder nozzle portion of the apparatus of FIG. 2.

FIG. 4 is a front view of an embodiment of a bladder retention component of a vehicle fluid delivery apparatus consistent with an embodiment of the present invention.

FIG. 5 is a perspective view of a plurality of vehicle fluid delivery apparatuses, consistent with an embodiment of the present invention, coupled to a carrier.

FIG. 6 is an end view of the carrier of FIG. 5.

FIG. 7 is a perspective view of another embodiment of a vehicle fluid delivery apparatus consistent with the present invention.

FIG. 8 is a side view of the apparatus of FIG. 7.

FIG. 9 is a perspective view of the nozzle portion of the apparatus of FIG. 7, with the cap removed.

### DETAILED DESCRIPTION OF THE PREFERRED EMBODIMENTS

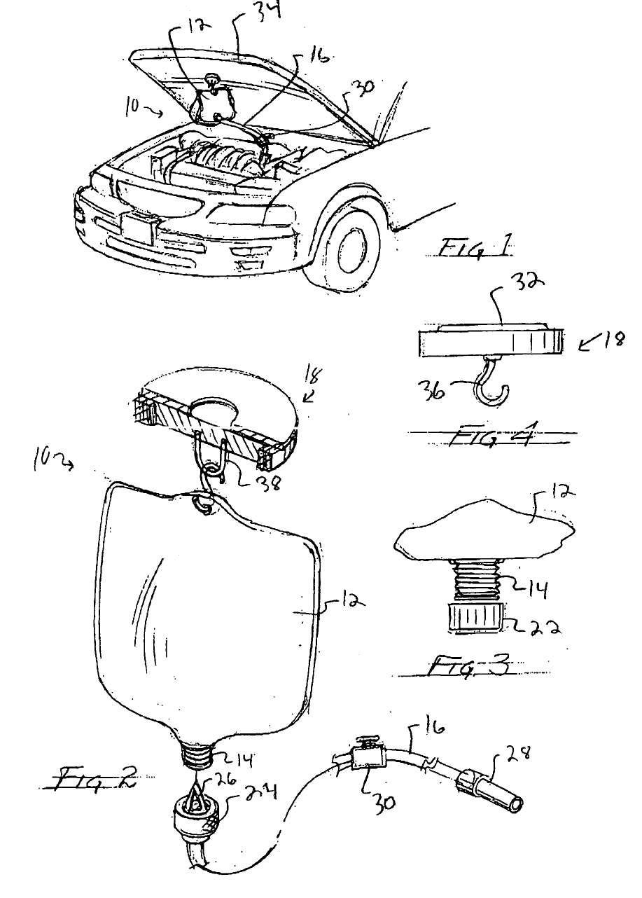

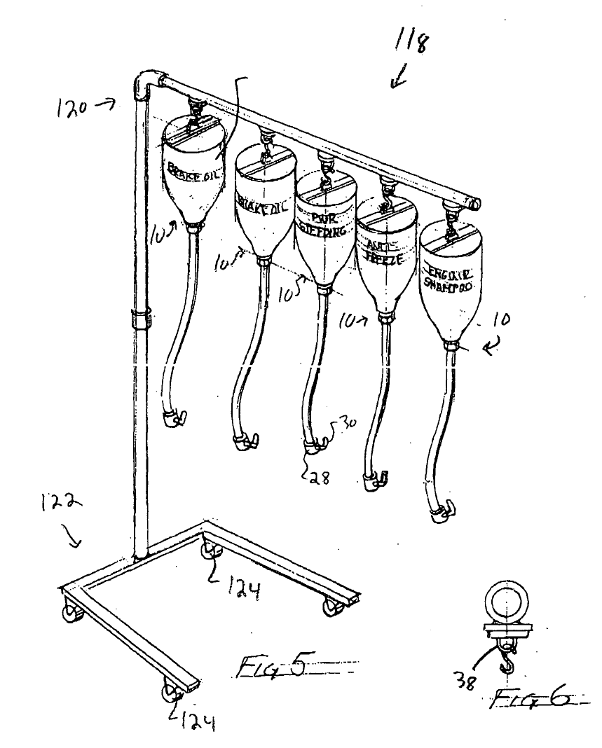

Referring first to FIGS. 1-4, an embodiment of a vehicle fluid delivery apparatus 10 (herein “apparatus 10”) consistent with the present invention is shown. The main components of the apparatus 10 are a flexible container 12 (“container 12”), a nozzle 14, and a hose 16 coupled to the nozzle 14. Preferably, though not necessarily, a carrier 18 is also utilized.

Referring first to the container 12, it is preferably comprised of a plastic type of material or other type of flexible material such as a combination of plastic and foil. It should be sufficiently flexible so that its sides will contract against each other as vehicle fluid exits therefrom, reducing its size as compared to when it is in a filled condition. It may be bladder type, and may have a pouch shape (see, e.g., FIGS. 1-2), or other desired configuration.

The nozzle 14 is preferably located so as to be proximate the top of the container 12 when the container 12 is in position upside down on a carrier 18 or otherwise held aloft. Vehicle fluid exits via the nozzle 14, and the container 12 is also, preferably, filled via nozzle 14.

Preferably, the nozzle 14 is sealed with a seal (not shown), which may be foil-type, plastic or foam, after it is filled with vehicle fluid. The nozzle 14 should be additionally secured with a threaded cap 22 that mates with the nozzle 14, for storage or transport purposes, when the hose 16 is not in place.

A hose 16 is preferably coupled at its first end to the nozzle 14. Preferably, the hose 16 has at its first end a threaded cap 24 that mates with the nozzle 14, so as to facilitate coupling therebetween. It would be preferred to position within the threaded cap 24 a bayonet tip 26, to pierce the seal (not shown) and permit the flow of vehicle fluid through hose 16.

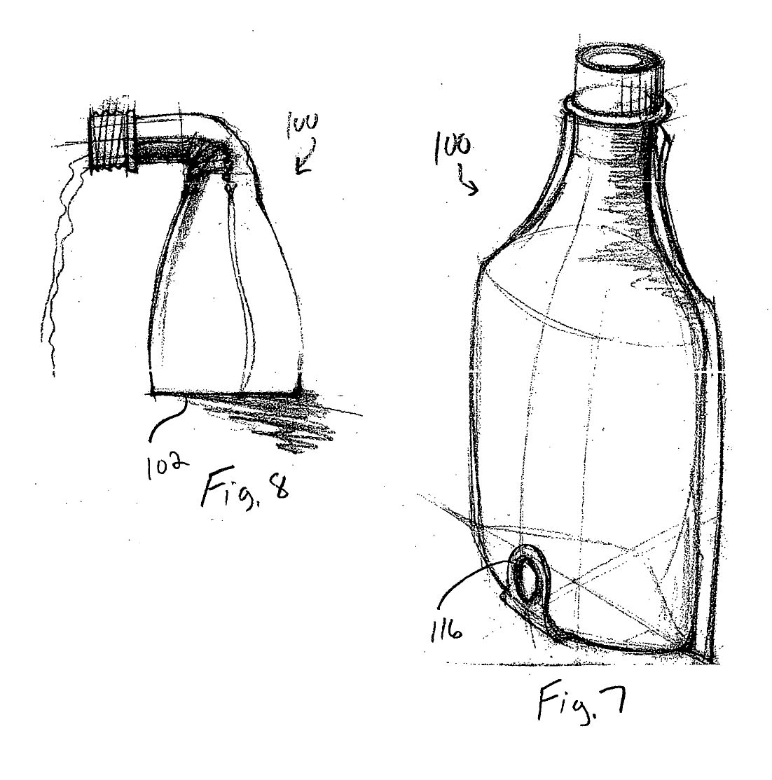

The second end of the hose 16 is preferably fitted with a nozzle 28, perhaps having a slight taper, which is dimensioned to be insertable into at least one and preferably a plurality of vehicle fill openings, such as the opening for inserting brake fluid, transmission fluid, oil, etc. It is preferred to utilize a closeable valve to regulate the flow of vehicle fluid out of the second end of the hose 16. Preferably, a valve 30 is located along the hose 16 (see FIGS. 1 and 2). The valve 30 may, alternatively, be integral with the nozzle 28 (see, e.g., FIG. 5), or it may be integral with the nozzle 14.

As an alternative to positioning the nozzle 28 into a fill opening, it may be desired to couple it to another apparatus. For example, where the vehicle fluid is engine shampoo or degreaser, it may be desired to couple the nozzle 28 directly to an engine cleaning gun to spray on the engine shampoo or degreaser.

When it is desired to use the container 12 to add vehicle fluid, it is preferred to hang the container 12 in a location that is higher than the fill opening through which fluid is to be added, so that vehicle fluid can by force of gravity flow out of the container 12. A carrier 18 may be utilized for this purpose. Referring first to FIGS. 1, 2 and 4, the carrier 18 may have a magnet backing 32, so as to be coupleable to the interior of a raised vehicle hood 34. The carrier 18 may have a hook 36 or U-shaped projection 38 descending from a bottom thereof, to which the container 12 may be coupled. In one embodiment, the apparatus 10 should be packaged for sale together with at least one carrier 18.

Referring now to FIGS. 4-5, a plurality of apparatuses 10 are shown coupled to a mobile carrier 118. The mobile carrier can be configured as desired. In the embodiment shown in FIG. 5, an L-shaped, preferably adjustable arm 120 is coupled to a base 122 having a plurality of wheels 124 thereunder, so that the mobile carrier 118 may be wheeled into and out of position for use.

The horizontal portion of the L-shaped arm 120 preferably is adapted to accommodate a plurality of apparatuses 10 thereon. It may have, for example, a plurality of U-shaped projections 38 thereon (see, e.g., FIG. 6), to which a container 12 may be coupled. As indicated on the surface of the container 12's in FIG. 5, the container 12's may carry different vehicle fluids—such as brake oil, power steering fluid, anti-freeze, or engine shampoo. As shown in FIG. 5, two or more of the apparatuses 10 may contain the same vehicle fluid.

As also shown in FIG. 5, in one embodiment, the apparatus 10 has a substantially flat end. Such a configuration permits the apparatus 10 to be positioned in a standing position on a shelf, whether for sale or storage purposes.

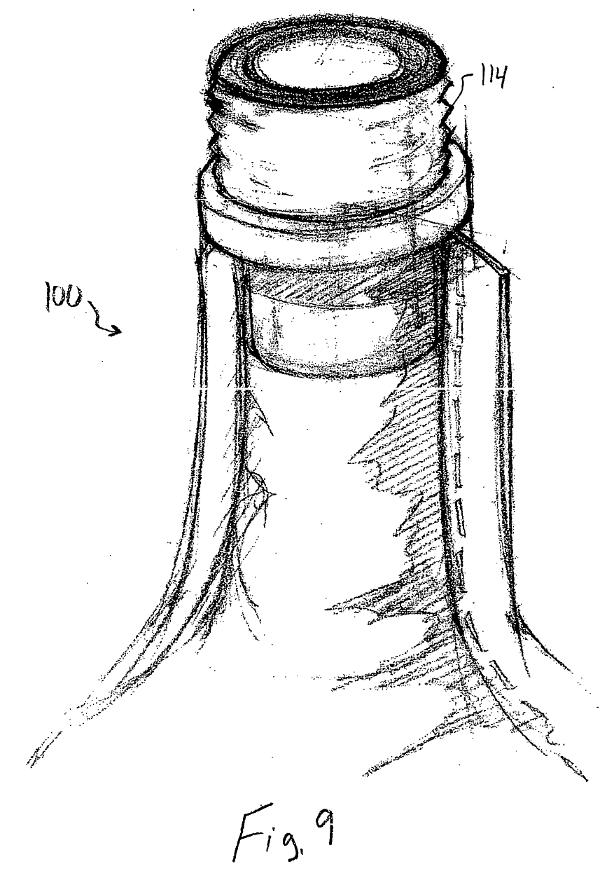

Referring now to FIGS. 7-9, another embodiment of a vehicle fluid delivery apparatus (hereinafter “apparatus 100”) consistent with the present invention is shown. In this embodiment, the apparatus 100 is shown as having a flat bottom 102, so that the apparatus 100 may stand upright when in a filled condition. This configuration is intended to permit the positioning of the apparatus 100 on a shelf or like surface, whether for display in a retail environment or for storage. As shown in FIG. 8, it may be desired to provide the apparatus 100 with a bendable gooseneck 104, to provide greater fill convenience.

As shown in FIG. 9, the apparatus 100 preferably has a nozzle 114. The nozzle 114 preferably has a threaded exterior, so that it may threadably engage a mating cap 122 as shown in FIG. 7. The apparatus 100 preferably has an eyelet 116 located proximate the flat bottom 102, so that the apparatus 100 may be hung with the nozzle 114 in a downward orientation during the filling process.

In general, with respect to the apparatus 10 and the apparatus 100, it should be noted that it may be desired to sell units on an individual basis either with or without surrounding packaging, or packaged in a multi-unit container. Where multiple apparatuses 10 or 100 are to be sold together in a single package, it may be desired to include in such package a carrier 18 or the like.

As used herein, including within the claims, the term “vehicle fluid” is meant to include any liquid that may be utilized in connection with the maintenance, operation or cleaning of a vehicle. This includes any liquid identified anyway herein, including without limitation brake fluid, transmission fluid, motor oil, additives, windshield washing fluid, engine shampoo, anti-freeze/coolant, gear oil, and power steering fluid.

While the invention has been particularly shown and described with reference to preferred embodiments thereof, it will be understood by those skilled in the art that the foregoing and other changes in form and details may be made therein without departing from the spirit and scope of the invention.

1. A vehicle fluid delivery apparatus comprising, in combination:
a flexible vehicle fluid container;
vehicle fluid located in said flexible bladder;
a first nozzle coupled to said flexible bladder and permitting said vehicle fluid to exit said flexible bladder; and
a hose coupled at a first end thereof to said first nozzle.

2. The vehicle fluid delivery apparatus of claim 1 wherein said flexible vehicle fluid container is a bladder.

3. The vehicle fluid delivery apparatus of claim 1 wherein said flexible vehicle fluid container is pouch-shaped.

4. The vehicle fluid delivery apparatus of claim 1 wherein said vehicle fluid is one of transmission oil, motor oil, engine shampoo, engine cleaner, windshield washing fluid, anti-freeze/coolant, power steering fluid, and brake fluid.

5. The vehicle fluid delivery apparatus of claim 1 further comprising a valve to regulate flow of vehicle fluid out of said flexible vehicle fluid container.

6. The vehicle fluid delivery apparatus of claim 1 wherein said first nozzle is sealed.

7. The vehicle fluid delivery apparatus of claim 6 wherein said seal is one of foil-type, plastic and foam.

8. The vehicle fluid delivery apparatus of claim 1 further comprising a cap dimensioned to cover said first nozzle.

9. The vehicle fluid delivery apparatus of claim 6 further comprising a cap dimensioned to cover said first nozzle.

10. The vehicle fluid delivery apparatus of claim 9 wherein said cap has a bayonet tip therein adapted to pierce said seal.

11. The vehicle fluid delivery apparatus of claim 1 wherein said hose has a second nozzle at a second end thereof.

12. The vehicle fluid delivery apparatus of claim 11 wherein said second nozzle is adapted to be positioned proximate a vehicle fluid fill opening.

13. The vehicle fluid delivery apparatus of claim 1 further comprising an attachment device adapted to attach said flexible vehicle fluid container to an object.

14. The vehicle fluid delivery apparatus of claim 13 wherein said object is a vehicle hood.

15. The vehicle fluid delivery apparatus of claim 13 wherein said object is a mobile carrier.

16. A method for providing vehicle fluid to a vehicle comprising the steps of:
providing a flexible vehicle fluid container;
inserting vehicle fluid into said flexible vehicle fluid container;
providing a first nozzle coupled to said flexible bladder and permitting said vehicle fluid to exit said flexible bladder;
providing a hose coupled at a first end thereof to said first nozzle;
positioning said first nozzle proximate a fill opening for vehicle fluid;
permitting said vehicle fluid to exit said flexible vehicle fluid container and enter said fill opening.

17. The method of 16 wherein said flexible vehicle fluid container is a bladder.

18. The method of claim 16 wherein said vehicle fluid is one of transmission oil, motor oil, anti-freeze/coolant, power steering fluid, and brake fluid.

19. The method of claim 16 further comprising the step of providing a valve to regulate flow of vehicle fluid out of said flexible vehicle fluid container.

20. The method of claim 16 further comprising the step of attaching said flexible vehicle fluid container to an object.
